(19) United States
(12) Patent Application Publication
(10) Pub. No.: US 2013/0242085 A1
(43) Pub. Date: Sep. 19, 2013

(54) DEVICE FOR USE IN INSPECTION OF CONTAINER, INSPECTION SYSTEM AND INSPECTION METHOD

(71) Applicant: KRONES AG, Neutraubling (DE)

(72) Inventor: Thorsten Gut, Neutraubling (DE)

(73) Assignee: Krones AG, Neutraubling (DE)

(21) Appl. No.: 13/795,230

(22) Filed: Mar. 12, 2013

(30) Foreign Application Priority Data
Mar. 16, 2012 (DE) DE102012102221.6

(51) Int. Cl. G01N 21/958

(52) U.S. Cl. CPC G01N 21/958
USPC 348/127

(57) ABSTRACT

A device for use in the inspection of a container, an inspection system and an inspection method are provided. The device comprises a protection pane for protecting a first space being separated by the protection pane from a second space for arrangement of the container, and a predetermined mark being arranged on the protection pane so that it is arrangeable on the device in a detecting range of a detecting unit for detection, wherein the detecting range is used for detecting at least one part of the container.

### CROSS-REFERENCE TO RELATED APPLICATION

This application claims foreign priority based on German patent application DE 10 2012 102 221.6, filed on Mar. 16, 2012, the content of which is incorporated herein by reference in its entirety.

### BACKGROUND OF THE INVENTION

1. Field of the Invention

The invention relates to a device for use in an inspection of a container, an inspection system and an inspection method, and in particular to a device, an inspection system and an inspection method, which are used in a container treatment plant for inspection of containers arranged in a stream of containers.

2. Description of the Prior Art

In the production of containers, like for example glass bottles for accommodating a product, in particular a beverage, a cleaning liquid, etc., the containers are guided in a row one after another, which is a so-called production stream along an inspection system to examine the containers in respect of defects. Herein, an empty container is inspected from above or laterally, for example, before the container is filled. In doing so the avoidance of a contamination of the containers is highest bid. Primarily, it is to be avoided that glass fragments get into an empty container.

However, it is problematic that parts of the inspection system, like a detecting unit, a lamp, etc., are to be incorporated into a waterproof housing to protect the parts against humidity. This housing is namely covered in the direction of the containers with a glass pane. The glass pane can be destroyed in case of a defect in the production stream. Thereby, there is the risk that glass fragments of the glass pane can get into the empty containers. In addition, no fast resumption of the production is possible in the case of a breakage of the glass pane, since the tightness of the housing against water must again be secured in an exchange of the glass pane, and further, the detecting unit and/or the lamp in the housing might already be damaged. Due to this reason it is conceivable that, between the glass pane and the production stream, an additional protection pane is arranged which can be removed with a flick of the wrist in case of a breakage and replaced by a new protection pane. In such a case, the tightness of the housing is preserved.

However, difficulties arise in case a broken protection pane is not replaced. Even if the production can continue for the time being, the glass pane of the housing might break in which the detecting unit and/or the lamp are/is incorporated. Thereby, remarkable production delays are caused anyway. In addition, the risk is much higher, that a glass fragment gets into an empty container.

DE 203 14 918 U1 discloses a device for monitoring, in respect of breakage and/or contamination, a protection glass of a laser optic of a material treatment device. By coupling in electromagnetic radiation via the end face of the protection glass it is detected with a photo detector whether or not the protection glass pane is broken.

However, in the inspection systems presently used in a container treatment plant, it is not possible to determine, whether or not a protection pane is mounted in front of the glass pane of the housing. Moreover, a proximity switch must be used to determine the position of devices in the proximity of the glass pane.

Due to this, there is a need for a simpler and cheaper possibility to monitor a protection glass in respect of presence and/or breakage and/or correct mounting.

### SUMMARY OF THE PRESENT INVENTION

Thus, it is an object of the invention to provide a device for use in the inspection of a container, an inspection system and an inspection method with which the above-mentioned problems can be solved. In particular, a device, an inspection system and an inspection method shall be provided with which proof can be furnished that in the proximity of a glass pane of a housing in which a detecting unit and/or a lamp is mounted, all units are mounted so that these units do not cause a defect in the production stream of the containers and/or a contamination of the containers.

The object is solved by a device for use in the inspection of a container which device has a protection pane for protecting a first space being separated by the protection pane from a second space for arrangement of the container, and a predetermined mark being arranged on the protection pane so that the predetermined mark is arrangeable on the device in a detecting range of a detecting unit for detection, wherein the detecting range is used or acts for detecting at least one part of the container.

In using the device in an inspection system, damages can be verified which arose due to a missing protection pane.

The arrangement and form of the predetermined mark can be documented to assess a change of the protection pane before a servicing is performed by an operator.

It is further possible to inspect units in the detecting range of the detecting unit in terms of completeness and/or their position. Therewith, a proximity switch for detecting the position of these units can be omitted.

Advantageous further developments of the device are given in the dependent claims.

It is advantageous that the device further comprises a cover pane for liquid sealing the device.

Preferably, the protection pane is an exchangeable protection pane for protecting the cover pane against objects in the second space in case of a breakage of the container.

It is possible that the device is an illumination device for illuminating a container to be inspected, wherein the illumination device comprises a housing and a lamp for radiation of light in the direction of the container to be inspected, and wherein the cover pane seals the housing liquid-tightly to protect the lamp mounted in the housing. Alternatively, the device can be a detecting device for detecting a container to be inspected, wherein the detecting device comprises a housing and a detecting unit for detecting at least one part of the container to be inspected, and wherein the cover pane seals the housing liquid-tightly to protect the detecting unit mounted in the housing.

In a preferred development, the predetermined mark is applied to the protection pane or the protection pane is a laminated glass pane between the laminated glass panes of which the predetermined mark is added.

The predetermined mark can be detectable by at least one illumination of an illumination with visible light or UV-light or IR-light and/or the predetermined mark can be asymmetric.

The above-mentioned object is further solved by an inspection system for inspection of a container for accommodating a product, which inspection system comprises a device as described above and an evaluation unit for evaluating whether or not the predetermined mark was detected in the detecting range in the inspection of the container, wherein the detecting unit is configured and/or arranged so that it can detect a range being arranged in the surroundings of the container and being for arrangement of the predetermined mark. Herein, it is possible that the detecting device is a camera and/or a detecting result of the detecting device is storable together with a time stamp.

The above-mentioned object is further solved by an inspection method for inspecting a container for accommodating a product, wherein the inspection method comprises the steps of: detecting by a detecting unit, at least one part of a container to be inspected, and evaluating, whether or not a predetermined mark was detected in the inspection of the container on a protection pane in the surroundings of the container.

Preferably, the inspection method further comprises the step of storing a detecting result of the detecting unit together with a time stamp and/or outputting a warning by a warning unit when the detecting unit does not detect the predetermined mark.

The inspection system and the inspection method achieve the same advantages as they are mentioned in respect of the device.

Further possible implementations of the invention comprise also combinations of features or styles described above or in the following with reference to the embodiments, even if they are not explicitly mentioned. Herein, the person skilled in the art will also add single aspects as improvements or additions to the respective basic form of the invention.

### BRIEF DESCRIPTION OF THE DRAWINGS

In the following, the invention is described in more detail by means of embodiments and with reference to the appended drawing Figures, wherein:

FIG. 1 shows a container treatment plant having an inspection system according to a first embodiment;

FIG. 2 shows an illustration illustrating in more detail the inspection system having a device according to the first embodiment;

FIG. 3 shows a three-dimensional view of a device according to the first embodiment;

FIG. 4 shows a view of a detecting result of the inspection system according to the first embodiment;

FIG. 5 shows a view of a further detecting result of the inspection system according to the first embodiment;

FIG. 6 shows a simplified illustration of an inspection system having a device according to a second embodiment;

FIG. 7 shows a simplified sectional view of a protection pane of the device according to the second embodiment;

FIG. 8 shows a simplified illustration of an inspection system having two devices according to a third embodiment;

FIG. 9 shows a view of a detecting result of the inspection system according to the third embodiment; and

FIG. 10 shows a view of a further detecting result of the inspection system according to the third embodiment.

In the figures, the same or functionally same elements are provided with the same reference signs unless given otherwise.

### DETAILED DESCRIPTION OF THE PRESENT INVENTION

FIG. 1 shows very schematically a plant 1 for treating of objects 2, like for example a container treatment plant 1 for treating of containers 2, etc. In the following, the invention is described on the basis of a container treatment plant 1, even if the invention is not limited thereto.

The containers 2 are inspectable in respect of correct shape and/or breakage and/or material defect etc. with an inspection system 3 according to the present embodiment. In the container treatment plant 1, the containers 2 are transported in a row one after another, that means in a production stream, through the container treatment plant 1 and also through the inspection system 3. The containers 2 can be, for example, finished containers like, in particular, bottles made of plastic or glass, cans, etc., in which a product can be filled. The product can be a liquid, in particular a beverage, a detergent, etc. However, the containers 2 can also be preforms made of plastics, like polyethylene terephthalate (PET), polypropylene (PP) etc., from which the containers can be produced.

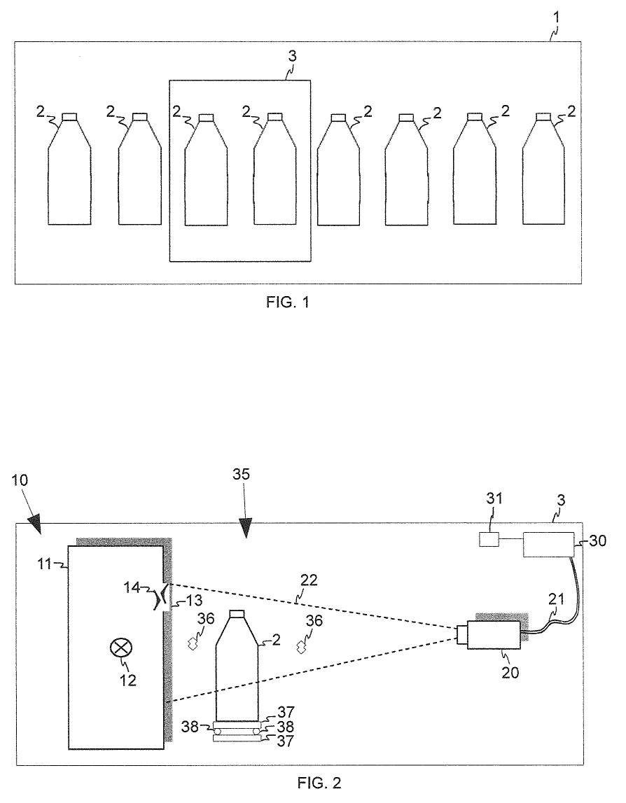

FIG. 2 shows in more detail the inspection system 3 for inspecting a container 2 and comprising a device 10 and a detecting unit 20. The detecting unit 20 is connected by an electric line 21 with an evaluating unit 30 which can output signals by a warning unit 31. The detecting unit 20 is shown in FIG. 1 as a camera, for example.

The device 10 has a housing 11, a lamp 12 and a protection pane 13 which is provided with a predetermined mark 14. The lamp 12 illuminates the container 2 so that the detecting unit 20 can detect in a detecting range 22 at least one part of the container 2 as shown in FIG. 2. The device 10 can thus also be denoted as illumination device 10.

The protection pane 13 acts as protection of a first space built by the device 10, in more detail its housing 11, against damages by objects in a second space 35, which objects might be loose objects 36. The objects 36 are in particular glass fragments, from the production stream of the containers 2, glass fragments of the protection pane 13, objects of the transport system for the containers 2, etc. The protection pane 13 separates the housing 11 of the device 10, the first space 11, thus from a second space 35 in which the containers 2 are guided on a band-conveyor 37 through the inspection system 3. The band-conveyor 37 is driven in FIG. 2 by a belt 38, for example.

In FIG. 2, the predetermined mark 14 is arranged in the detecting range 22 of the detecting unit 20, as well, and thus detectable by the detecting unit 20. The detecting result of the detecting unit 20 is transmitted by the electric line 21 to the evaluating unit 30, which can include a storing unit which is not shown. Alternatively, the storing unit can also be provided in the detecting unit 20 and/or as a separate unit. The evaluating unit 30 can evaluate, in other words determine, on the basis of the detecting result given by the detecting unit 20, whether or not the predetermined mark 14 was detected in the detecting range 22.

Hence, by means of the predetermined mark 14, proof can be furnished, whether or not the protection pane 30 was present in the inspection with the inspection unit 3. In case the predetermined mark 14 is not present, the evaluating unit 13 can output a warning by the warning unit 31, so that an operator is prompted to insert/exchange/mount correctly the missing and/or broken and/or inaccurate mounted protection pane 13.

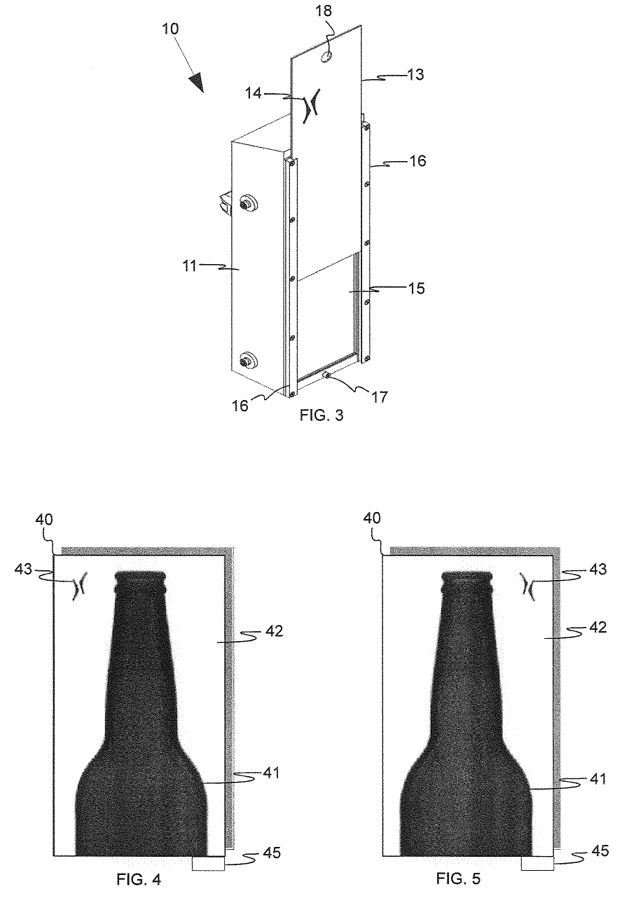

FIG. 3 shows the device 10 of FIG. 2 in more detail. The device 10 has in the illustrated example an ashlar-formed housing 11, which is sealed impermeably by a cover pane 15. The term “impermeable” means here in more detail that no liquid can get into the housing 11, so that it is talked also about a liquid-tight sealing of the housing 11 in the following. At the housing 11, two guiding rails 16 are mounted adjacent to the cover pane 15 so that the protection pane 13 can be mounted, guided by the guiding rails 16, on the housing 11 in front of the cover pane 15. A burling 17 acts as a limitation of the movement of the protection pane 13 to the bottom, as shown in FIG. 3. That means, the protection pane 13 abuts to the burling 17, in case the protection pane 13 is correctly mounted on the housing 11. An opening 18 in the protection pane 13 eases grabbing of the protection pane 13 with the hand of an operator when the protection pane 13 is to be mounted or dismounted. That is, the protection pane 13 is easily exchangeable from the device 10.

As apparent from FIG. 3 together with FIG. 2, the predetermined mark 14 is added to the protection pane 13 so that the predetermined mark 14 is present in the detecting range 22 of the detecting unit 20 when the protection pane 13 is mounted on the device 10 in front of the cover pane 15 and abuts to the burling 17.

FIG. 4 is a reproduction of the detecting result of the detecting unit 20, when the predetermined mark 14 is arranged at the device 10, as shown in FIG. 2. More precisely, FIG. 4 shows a detecting range image 40, in which a container detection image 41 and a surroundings detection image 42 are included. The container detection image 41 is an image of the detected part of the container 2 which image is illustrated in FIG. 4 only very simplified. The surroundings detection image 42 is an image of the detected surroundings of the detected part of the container 2, which image is also shown very simplified. In the surroundings detection image 42 is contained a mark image 43 of the predetermined mark 14. The reference sign 45 designates a time stamp.

The detecting results of the detecting unit 20 can be stored in the evaluating unit 30 together with the time stamp 45. Therewith, it can be assessed when the respective protection pane 13 was not present and/or was incorrectly mounted and/or was broken.

As a result, the predetermined mark 14 of the protection pane 13 is arranged in the detecting range 22 of the detecting unit 20, when the protection pane 13 is correctly and/or almost correctly mounted on the device 10.

FIG. 5 shows a reproduction of the detecting result of the container 2, when the protection pane 30 (FIG. 3) with the predetermined mark 14 (FIG. 3) is inserted upside down in the guiding rails 16 (FIG. 3) of the device 10. In this case, the predetermined mark 14 (FIG. 3) is present on the right side of the opening 18 (FIG. 3) of the protection pane 13 (FIG. 3). As a result, the mark image 43 is arranged on the right side of the container image 41 in FIG. 5, too. However, the mark image 43 is still present in the surroundings detection image 42, as shown in FIG. 5.

Since the predetermined mark 14 shown in FIG. 2 to FIG. 5 is asymmetric, it can be assessed with the evaluating unit 30 on the basis of the detecting result of the detecting unit 20, how the protection pane 13 is mounted on the device 10. In other words, by an asymmetric symbol of the predetermined mark 14, the mounting position and/or the latching and/or the orientation of the protection pane 13 can be monitored. It can be assessed further, whether the device 10 is correctly pivoted into the inspection system 3, in case the device 10 is mounted as a wall lamp, for example.

In the present embodiment, the protection pane 13 is set into the device 10 from above. The cover pane 15 can be inserted liquid-tight in the manufacturing of the device 10 in the factory and is not to be replaced in the event of a breakage of the protection pane 13.

The evaluating unit 30 can also provide that the last detecting results in which the protection pane 13 was present are archived by the means of an FIFO-storage (First-In-First-Out-storage), that is by the means of a storage in which the element stored first is also taken out of the storage first. Hereby, it can be verified that the protection pane 13 was mounted in a predetermined inspection performed with the inspection system 3 or not.

The evaluating unit 30 can also be readout by means of remote maintenance (teleservice) so that it can be assessed also at another place than the installation location of the container treatment plant 1 or the inspection system 3, whether or not the protection pane 13 was mounted.

In addition, a further feature is recordable, in particular that the protection pane 13 was present and not broken.

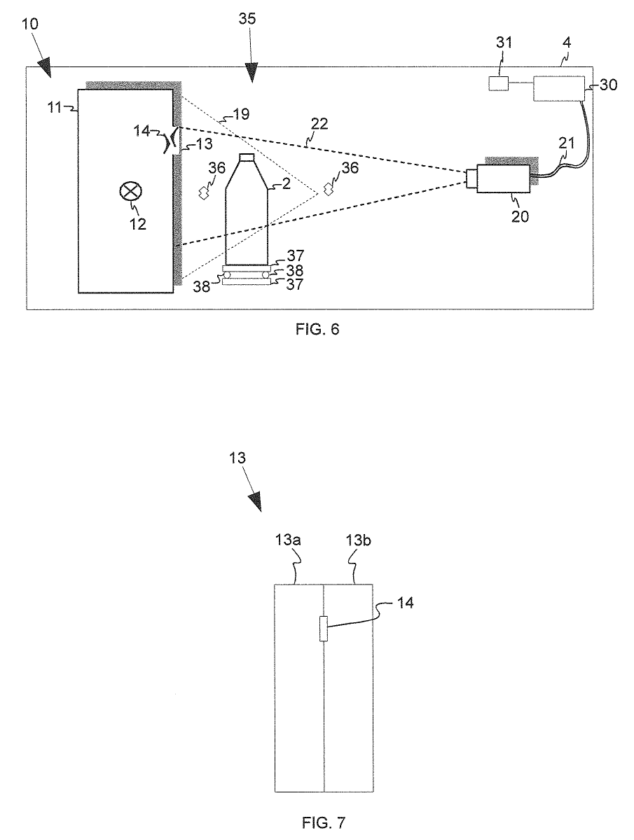

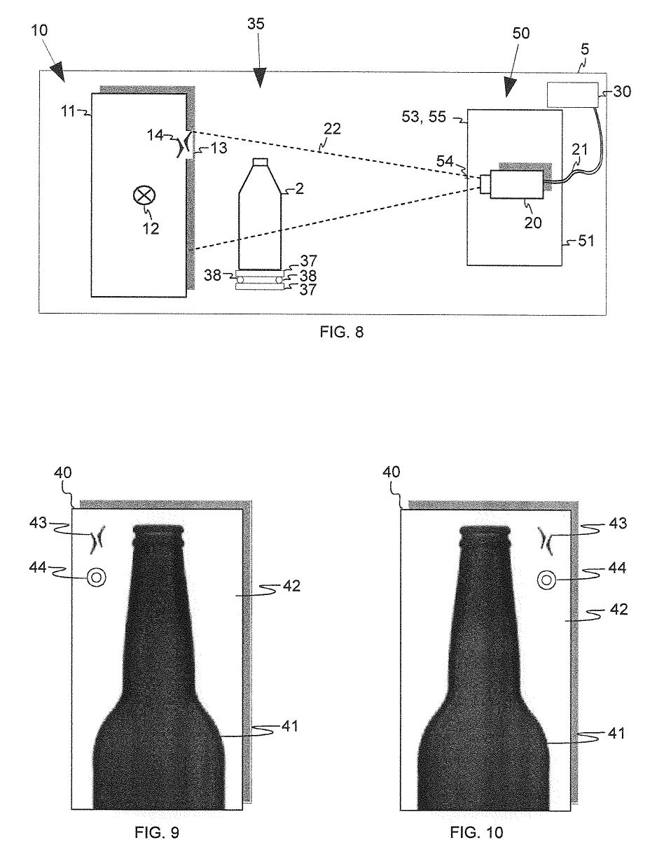

FIG. 6 shows an inspection system 4 according to a second embodiment. The inspection system 4 according to this embodiment is configured in most parts like the inspection system 3 of the first embodiment so that only the differences between the preceding and the present embodiment are described in the following.

In this embodiment, the device 10 radiates light 19 in the visible and/or invisible wavelength range. As a result, the predetermined mark 14 can be in the visible and/or invisible wavelength range. The usage of invisible light, for example in the infrared and/or ultraviolet wavelength range, is in particular advantageous, if no free portion in the detecting range 22 of the detecting unit 20 is available. In respect of the ultraviolet wavelength range, the predetermined mark 14 can be applied to the protection pane30 with ultraviolet paint, and the presence of the protection pane 13 and/or the protection pane 53 can be assessed by ultraviolet light (impinging light) in a test modus. In respect of the infrared wave length range, the predetermined mark 14 can be implemented by one or more infrared blockers at the protection pane 13, and the presence of the protection pane 13 can be assessed by infrared light (transmitted light) in a test modus.

FIG. 7 shows further that the protection pane 13 in the present embodiment is made of laminated glass panes 13a, 13b, preferably, laminated safety glass panes. The predetermined mark 14 is added between the laminated glass panes 13a, 13b. That means, the predetermined mark 14 is added at one of the laminated glass panes 13a, 13b on the face which is oriented toward the other one of the laminated glass panes 13b, 13a. The predetermined mark 14 can, however, also be added to one of the laminated glass panes 13a, 13b on the face which is averted from the other one of the laminated glass panes 13b, 13a.

FIG. 8 shows an inspection system 5 according to a third embodiment. The inspection system 5 according to the present embodiment is configured in most parts like the inspection system 3 of the first embodiment, so that only the differences between the first and the present embodiment are described in the following.

In the present embodiment, also the detection unit 20 is mounted in a device 50. The device 50 is configured in the same way as the device 10, however, the detecting unit 20 is mounted into the device 50 instead of the lamp 12. As a result, the device 50 can also be denoted as detecting device 50.

That means, the device 50 has a housing 51, a protection pane 53 provided with a predetermined mark 54, and a cover pane 55. The cover pane 55 is illustrated in FIG. 8 for simplification of the illustration together with the protection pane 53 as one part, even if actually two separate parts are concerned. The protection pane 53 separates the housing 51 of the device 50, a first space 51, from the second space 35, in which the containers 2 are guided on the band-conveyor 37 through the inspection system 3.

In FIG. 8, also the predetermined mark 54, like the predetermined mark 14 of the protection pane 13 of the device 10, is arranged in the detecting range 22 of the detecting unit 20, in case the protection pane 53 is mounted correctly and/or almost correctly on the device 50. Consequently, the outcome of this is a detecting result as shown in FIG. 9 and FIG. 10 when the assembly is correct and/or almost correct.

FIG. 9 shows the detecting result of the detecting unit 20 in the present embodiment, wherein the detecting result comprises in addition a mark image 44 of the predetermined mark 54. Since the predetermined mark 54 is symmetric, as shown in FIG. 6, it cannot be recognized absolutely unambiguously, whether or not the protection pane 53 was inserted in the right direction.

FIG. 10 shows the case in which the protection pane 53 and the protection pane 13 are inserted the other way round as in the case shown in FIG. 9.

Consequently, proof can be furnished in the present embodiment like in the preceding embodiment, that the protection pane 13 and/or the protection pane 53 was present in the inspection with the inspection device 5 or not. Further, the other proofs can be furnished like in the preceding embodiments. For more details, it is referred to the description of the first embodiment.

According to a modification of the present embodiment, the predetermined marks 14′ can be located on two panes of a lamp housing, for example, the housing 11 of the device 10, which panes are arranged one behind the other. Herein, the predetermined mark 14 can be added or applied to the protection pane 13, whereas the predetermined mark 54 is added or applied to the housing pane 15. Also in the present case, the result is a detecting image 40 as shown in FIG. 9 and FIG. 10. If the mark image 43 is not present on the detecting image 40, it will be advantageous to output a warning by the warning unit 31, since the protection pane 13 is missing. If, in contrast thereto, the other mark image 44 is missing in the detecting image 40 of the detecting device 20, preferably measures are to be taken for stopping the container treatment plant 1, since the liquid-tight housing pane 15 is missing.

All of the above-described implementations of the inspection system 3, 4, 5, the devices 10, 50 and the inspection method according to the first to third embodiments and its modifications can be used separately or in all possible combinations thereof. The features of the first to third embodiments and its modifications are combinable with each other arbitrarily. In addition, in particular, the following modifications are conceivable.

The elements shown in the figures are depicted schematically and can differ in the specific implementation from the forms shown in the figures provided that the above-described functions are ensured.

The predetermined mark 14 and the predetermined mark 54 are preferably arranged so that they can be imaged adjacent to each other in the detecting result of the detecting unit 20, as shown in FIG. 9 and FIG. 10. However, the predetermined mark 14 and the predetermined mark 54 can also overlap each other or be arranged completely above one another. In such a case it is however preferable that the predetermined mark 14 and the predetermined mark 54 are distinguishable clearly from one another.

The protection pane 13 and/or the protection pane 53 can be made from hardened glass, too. It is also conceivable that the protection pane 13 and/or the protection pane 53 have a thickness of about 20 mm.

It is possible to start, before a production with the container treatment plant 1 takes place, a test modus by a control of focus and/or aperture and/or a light intensity control, in which test modus the presence of the protection pane 13 and/or the protection pane 53 is assessed.

The detecting unit 20 can also detect the bottom of a container 2 and can therewith also monitor the belt 38 which can be a gear belt. Therewith, a correct function of the belt control of the band-conveyor 37 can be detected.

The predetermined mark 14 and/or the predetermined mark 54 can have any form. Preferably, the predetermined mark 14 and/or the predetermined mark 54 have/has a size of at least 5×5 mm. The form of the predetermined mark 14 and/or the predetermined mark 54 can be adjusted to applications specific to a user.

Among the transparent protection pane 13 and/or the transparent protection pane 53 apertures or the like can be controlled, as well, as long as they are arranged in the visible and sufficiently sharp imaging range of the detecting unit 20.

In case, a pluggable filter is present above the lamp 12 of the device 10, a coding can be present by means of a sufficiently large opening in the unused corners of the device 10, which coding can protect an operator against an operating error. An operating error can be, for example, that the operator uses a wrong aperture for a production type of containers 2.

For the protection panes 13, 53, basically all protection panes can be used which are detectable sharply up to a certain level with the detecting unit 20. In case, the detecting unit 20 is a camera, it is advantageous that the protection pane 13, 53 can be imaged sharply with the camera. Moreover, an optical coding of guidance rails or the like is possible.

In case the detecting unit 20 is a camera, the camera can use telecentric optics. The detecting unit 20 can be a photographic camera and/or a video camera.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

What is claimed is:

1. A device for use in the inspection of a container, the device comprising:
a protection pane for protecting a first space being separated by the protection pane from a second space for arrangement of the container, and
a predetermined mark being arranged on the protection pane so that said predetermined mark is arrangeable on the device in a detecting range of a detecting unit for detection, wherein the detecting range is used for detecting at least one part of the container.

2. The device according to claim 1, further comprising a cover pane for liquid-tightly sealing the device.

3. The device according to claim 2, wherein the protection pane is an exchangeable protection pane for protecting the cover pane against objects in the second space in case of a breakage of the container.

4. The device according to claim 2, wherein the device is an illumination device for illuminating a container to be inspected, wherein the illumination device comprises a housing and a lamp for radiation of light in the direction of the container to be inspected, and wherein the cover pane seals the housing liquid-tightly to protect the lamp mounted in the housing, or
wherein the device is a detecting device for detecting a container to be inspected, wherein the detecting device comprises a housing and a detecting unit for detecting at least one part of the container to be inspected, and wherein the cover pane seals the housing liquid-tightly to protect the detecting unit mounted in the housing.

5. The device according to claim 1, wherein the predetermined mark is applied to the protection pane or the protection pane is a laminated glass pane between the laminated glass panes of which the predetermined mark is added.

6. The device according to claim 1, wherein the predetermined mark is detectable by at least one illumination of an illumination with visible light or UV-light or IR-light and/or the predetermined mark is asymmetric.

7. An inspection system for inspection of a container for accommodating a product, the inspection system comprising
a device for use in the inspection of a container, which device comprises a protection pane for protecting a first space being separated by the protection pane from a second space for arrangement of the container, and a predetermined mark being arranged on the protection pane so that it is arrangeable on the device in a detecting range of a detecting unit for detection, wherein the detecting range is used for detecting at least one part of the container, and
an evaluation unit for evaluating whether or not the predetermined mark was detected in the detecting range in the inspection of the container,
wherein the detecting unit is configured and/or arranged so that it can detect a range being arranged in the surroundings of the container and being for arrangement of the predetermined mark.

8. The inspection system according to claim 7, wherein the detecting device is a camera and/or a detecting result of the detecting device is storable together with a time stamp.

9. An inspection method for inspecting a container for accommodating a product, the inspection method comprises the steps of:
detecting, by a detecting unit, at least one part of a container to be inspected, and
evaluating, whether or not a predetermined mark was detected in the inspection of the container on a protection pane in the surroundings of the container.

10. The inspection method according to claim 9, further comprising the step of
storing a detecting result of the detecting unit together with a time stamp, and/or
outputting a warning by a warning unit when the detecting unit does not detect the predetermined mark.
